(19) United States
(12) Patent Application Publication
(10) Pub. No.: US 2024/0241725 A1
(43) Pub. Date: Jul. 18, 2024

(54) PARALLEL DATA FILTERING AND TRANSMISSION

(71) Applicant: Ocius Technologies LLC, Akron, OH (US)

(72) Inventor: Dale H. Mugler, Highland Park, IL (US)

(21) Appl. No.: 18/407,879

(22) Filed: Jan. 9, 2024

Related U.S. Application Data
(60) Provisional application No. 63/480,423, filed on Jan. 18, 2023.

(51) Int. Cl. G06F 9/38; G06F 9/30

(52) U.S. Cl. CPC G06F 9/3885; G06F 9/30036; G06F 9/3851

(57) ABSTRACT

A method for processing data in parallel includes the steps of: (a) separating input data into a plurality of streams using the sumdiff function; (b) transforming the plurality of streams from step (a) into frequency domain in parallel using the FFTpc algorithm and the pDCTs algorithm; (c) transforming the frequency-domain plurality of streams from step (b) into time domain in parallel using the reverse FFTpc algorithm and the reverse pDCTs algorithm; and (d) combining the plurality of streams from step (c) into output data using the sumdiff function.

### I. BACKGROUND

This invention pertains to the art of data filtering and transmission using parallel computing. Performing data convolution or filtering in the time domain is much more computationally intensive than in the frequency domain for most applications, so due to the desire to reduce computation times, convolution or filtering is frequently done in the frequency domain. Parallel computing can reduce computation time, but the actual increase in speed depends on how much data moves between the parallel processors. A high amount of data movement between the parallel processors can negate any speed increase due to parallel processing of the data. To further increase the speed of filtering and convolution, this method and system are disclosed.

### II. SUMMARY

In accordance with one aspect of the present invention, a method for processing data in parallel includes the steps of: (a) separating input data into a plurality of streams by a computer executing the sumdiff function; (b) transforming the plurality of streams from step (a) into frequency domain in parallel using parallel processors, wherein (1) at least a portion of at least one of the plurality of streams is transformed using the FFTpc algorithm, and (2) the other portions and streams are transformed using the pDCTs algorithm; (c) transforming the frequency-domain plurality of streams from step (b) into time domain in parallel using parallel processors, wherein (1) the portion corresponding to step (b)(1) is transformed using the reverse FFTpc algorithm, and (2) the portions and streams corresponding to step (b)(2) are transformed using the reverse pDCTs algorithm; and (d) combining the plurality of streams from step (c) into output data by executing the sumdiff function. After step (b), the result is a parallel implementation of the fast Fourier transform (FFT) for 1D, 2D, or 3D, in either magnitude-correct or as exactly correct. If the output of step (b) is multiplied term-by-term by the filter function as transformed by the FFTpc algorithm prior to step (c), the final output after step (d) is a parallel implementation of spectral filtering.

In accordance with another aspect of the present invention, a method for processing data in parallel includes the steps of: (a) partitioning input data into a first half and a second half; (b) adding the first half from step (a) to the second half from step (a) term-by-term to produce a first half of a temporary vector; (c) subtracting the second half from step (a) from the first half from step (a) term-by-term to produce a second half of the temporary vector; (d) if the temporary vector is of size greater than 4, setting the first half of the temporary vector from step (b) as the input data and repeating steps (a)-(c), with each iteration generating a new temporary vector, until the latest temporary vector is of size 4 or less; (e) concatenating the latest temporary vector from step (d) with each second half of the temporary vector from step (c) for all prior iterations of step (d) to form vector sdvec; and (f) separating the sdvec from step (e) into a plurality of streams, wherein steps (a)-(f) are performed by one or more computers.

In accordance with still another aspect of the present invention, a method for processing data in parallel includes the steps of: (a) partitioning two-dimensional input data along the first dimension into a first half and a second half; (b) adding the first half from step (a) to the second half from step (a) term-by-term to produce a first half of a first temporary matrix; (c) subtracting the second half from step (a) from the first half from step (a) term-by-term to produce a second half of the first temporary matrix; (d) partitioning the first temporary matrix from steps (b)-(c) along the second dimension into a first half and a second half; (e) adding the first half from step (d) to the second half from step (d) term-by-term to produce a first half of a second temporary matrix; (f) subtracting the second half from step (d) from the first half from step (d) term-by-term to produce a second half of the second temporary matrix; (g) partitioning the second temporary matrix from step (f) into at least four subregions, wherein steps (a)-(g) are performed by one or more computers.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a diagram of a filter system.

FIG. 2 is a diagram of a filter system according to one embodiment of the invention.

FIG. 3 is a diagram of the parallel discrete cosine transforms algorithm.

FIG. 4 is a diagram of the reverse parallel discrete cosine transforms algorithm.

FIG. 5 is a diagram of a filter system according to another embodiment of the invention.

FIG. 6 is a diagram of a discrete cosine transform (type two) algorithm.

FIG. 7 is a diagram of a two-dimensional input data.

FIG. 8 is a diagram of a transform system.

FIG. 9 is a diagram of a filter system according to another embodiment of the invention.

FIG. 10 is a diagram showing subregions of two-dimensional data.

FIG. 11 shows a two-dimensional example input data x.

FIG. 12 shows x_{g} for the example of FIG. 11.

FIG. 13 shows xₕ for the example of FIG. 11.

FIGS. 14-17 show the subregions of xₕ for the example of FIG. 11.

FIG. 18 is a diagram showing subregions of two-dimensional data.

FIG. 19 is a diagram of a transmission system according to one embodiment of the invention.

FIG. 20 shows an 8×8 angle adjustment matrix A.

FIG. 21 shows an example of a symmetrical filter function h.

FIG. 22 shows the transform h of the filter function h of FIG. 21.

FIG. 23 shows an example of an 8×8 symmetrical 2D filter mask f.

FIGS. 24-27 show the subregions of the mask h of FIG. 23 after the interleaving adjustment.

FIG. 28 is a diagram of a filter system according to another embodiment of the invention.

### IV. DETAILED DESCRIPTION

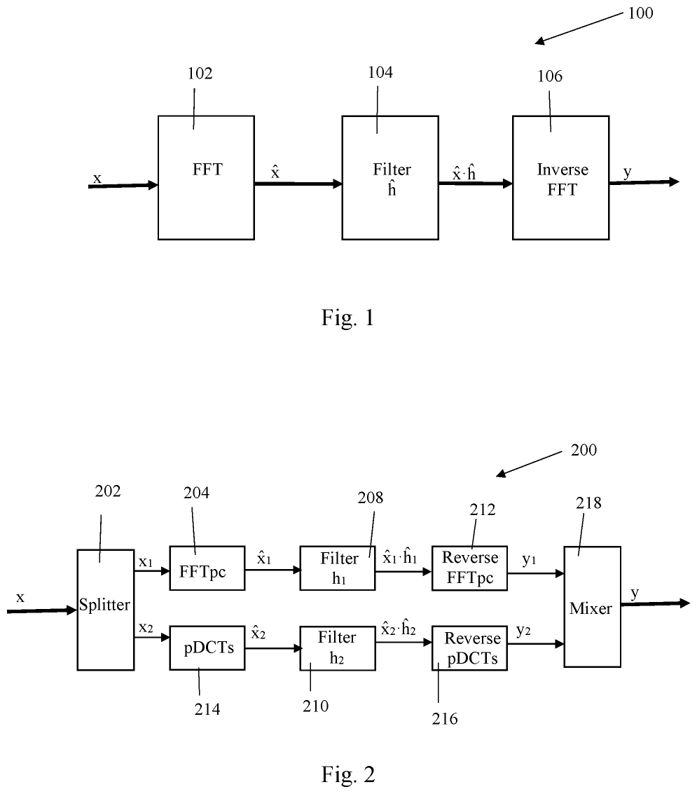

Referring now to the drawings wherein the showings are for purposes of illustrating embodiments of the invention only and not for purposes of limiting the same, and wherein like reference numerals are understood to refer to like components, FIG. 1 shows a diagram of an existing filter system 100 that takes input signal or data x and filters it into signal or data y. Some nonlimiting examples of filters are those that remove high frequency noise from a signal to be able to bring out the actual signal of interest, or those that sharpen or otherwise enable feature extraction of an image. Data filtering or convolution is symbolized by x*h, where x is the input data and h is the filter or convolution or impulse response function whose length is less than or equal to the length of x. If h is shorter than x, it can be extended to be the same length or size as x by adding zeros, for example. In this specification, data filtering is synonymous with data convolution, and signal is synonymous with data. For vectors x and h, each of length n, convolution in the time domain is defined by:

$$( x * h ) ( k ) = {\sum }_{m = 1}^{n} x ( m ) \cdot h ( k - m )$$

for k=1, 2, . . . , n. To perform convolution in the frequency domain, the input data x is converted from the time domain into the frequency domain using a fast Fourier transform (FFT) algorithm 102, the output of which is x. The frequency-domain data x is then filtered. This is accomplished by taking the filter function h and obtaining its discrete Fourier transform (DFT) ĥ, and then multiplying h by the frequency-domain input data & in filter algorithm 104. The term-by-term multiplication in the frequency domain is computationally simpler than the time-domain convolution equation listed above. Then, the filtered frequency-domain data \hat{x}·ĥ (which could also be thought of as ŷ) is converted back into the time domain through the inverse FFT algorithm 106 to produce the filtered output data y.

FIG. 2 shows a diagram of a filter system 200 according to one embodiment of the invention. The filter system 200 can process the input data x faster than the previously discussed filter system 100 by separating the input data x into multiple smaller streams and processing them in parallel. The input data x may be one-dimensional, two-dimensional, three-dimensional, or any higher-order dimension, and has a length or size that is a power of 2. The input data may be processed faster with this invention because separating the input data into portions allows them to be processed concurrently in parallel, rather than sequentially. Additionally, the separated data is smaller in size than the original, un-separated data, which allows it to be processed faster than the larger original data. Furthermore, the filter system 200 has a smooth and efficient transition between the sequential steps, as data from a preceding step is ready to be input into the subsequent step without reordering.

With continued reference to FIG. 2, the system 200 may separate the input data x using the splitter algorithm 202. In one embodiment, the splitter algorithm 202 may use a “sumdiff(x)” function, which takes the first half of input data x (called xₐ) and the second half of input data x (called x_{b}) and splits it into two equal-sized portions x₁ and x₂ as follows:

$$\begin{matrix}{x}_{1} = {x}_{a} + {x}_{b} \\ {x}_{2} = {x}_{a} - {x}_{b}\end{matrix}$$

The sumdiff function may be used throughout the filter system 200. In its generalized form “sumdiff(a, b),” it takes inputs a and b and generates two outputs, the first of which is a term-by-term addition a+b and the second of which is a term-by-term subtraction a−b. A useful property of the sumdiff function is that it is a constant multiple of its own mathematical inverse. I.e., if y=sumdiff(x) and if z=sumdiff(y)/2, then z=x. Because the sumdiff function is its own inverse, except for the divisor of 2, dividing by 2 in binary arithmetic is just a bit shift operation that adds no floating-point operations to the computation.

The splitter algorithm 202 may compute an intermediate vector called sdvec as follows. First, for input data x of size greater than 4 (e.g., 8, 16, 32, etc.), perform sumdiff(x) to obtain the sum x₁ and the difference x₂ portions. If the size of these portions concatenated is greater than 4, then perform the sumdiff function on just the sum portion x₁, which would generate a new sum portion x₁ and a new difference portion x_{2′}. If the size of these portions concatenated is greater than 4, then perform the sumdiff function on just that new sum portion x_{1′}, and so on with additional iterations. Finally, take the result of the final sumdiff function and concatenate with the difference portions of all prior sumdiff functions—this concatenated result is sdvec and is the same size as the input data x. The entries or portions of sdvec can then be used as the parallel streams for the rest of the filter system 200.

For example, if the input data x is a size-8 one-dimensional vector [1 7−2 4 21 0 2 6], then:

$$\begin{matrix}{x}_{a} = [ \begin{matrix}1 & 7 & - 2 & 4\end{matrix} ] \\ {x}_{b} = [ \begin{matrix}21 & 0 & 2 & 6\end{matrix} ] \\ {x}_{1} = [ \begin{matrix}22 & 7 & 0 & 10\end{matrix} ] \\ {x}_{2} = [ \begin{matrix}- 20 & 7 & - 4 & - 2\end{matrix} ]\end{matrix}$$

Since the concatenation of x₁ and x₂ is greater than size 4, the sumdiff function is next performed on x₁:

$$\begin{matrix}{x}_{a}^{′} = [ \begin{matrix}22 & 7\end{matrix} ] \\ {x}_{b}^{′} = [ \begin{matrix}0 & 10\end{matrix} ] \\ {x}_{1}^{′} = [ \begin{matrix}22 & 17\end{matrix} ] \\ {x}_{2}^{′} = [ \begin{matrix}22 & - 3\end{matrix} ]\end{matrix}$$

Since the concatenation of x_{1′} and x_{2′} is not greater than size 4, sdvec is the concatenation of x_{1′}, x_{2′}, and x₂, or [22 17 22 −3 −20 7−4 −2]. Thus, the outputs of the splitter algorithm 202 in this example are x₁=[22 17 22 −3] and x₂=[−20 7 −4 −2].

With continued reference to FIG. 2, the data x₁ may then be processed by the “FFTpc algorithm” 204 (where “p” stands for parallel and “c” stands for choice). This algorithm 204 is described in U.S. Pat. No. 9,298,674, titled Interleaved Method for Parallel Implementation of the Fast Fourier Transform, incorporated herein by reference. The algorithm 204 may use the option of no rotations in one embodiment (e.g., in applications where only the magnitude and not the exact value with phase is desired). To output the values of filtering in standard order, the outputs from each processor do not require interleaving, as in U.S. Pat. No. 9,298,674. For filtering, successive sumdiff operations on processor outputs provide the correct result.

In the one-dimensional example given above, with the input to the algorithm 204 being x₁=[22 17 22 −3], the transformed data x₁ is also a size-4 vector with its entries being:

$$\begin{matrix}Positions 1 and 3 = sumdiff ( positions 1 and 2 of {x}_{1} ) \\ Position 2 = ( position 3 of {x}_{1} ) - ( position 4 of {x}_{1} ) \cdot i \\ Position 4 = ( position 3 of {x}_{1} ) + ( position 4 of {x}_{1} ) \cdot i\end{matrix}$$

namely,

$$\begin{matrix}Position 1 of {\hat{x}}_{1} = 22 + 17 \\ Position 2 of {\hat{x}}_{1} = 22 - - 3 i \\ Position 3 of {x}_{1} = 22 - 17 \\ Position 4 of {\hat{x}}_{1} = 22 + - 3 i \\ such that {\hat{x}}_{1} = [ \begin{matrix}39 & 22 + 3 i & 5 & 22 - 3 i\end{matrix} ] .\end{matrix}$$

With continued reference to FIG. 2, the transformed data \hat{x}₁ may then be filtered. First the filter function h is transformed to ĥ using FFT. Where the filter or convolution function h is known in advance (i.e., where it is known through what filter the data is to pass), the filter's transform ĥ can be precomputed in advance also. The filter transform h may be computed using the same FFTpc algorithm 204 described above (only using the with-rotation option). The filter transform h may be split into as many component filters as there are parallel data streams. Instead of combining the outputs of the different parallel streams in the FFTpc algorithm 204 (described in U.S. Pat. No. 9,298,674) at the end, they are kept separate to allow different component filters to be applied to different input data streams. In other words, the subvectors of ĥ (e.g., ĥ₁, ĥ₂, etc.) are set up to match with the parallel streams of \hat{x} (e.g., \hat{x}₁, \hat{x}₂, etc.) for the term-by-term product. The filter system 200 may then multiply the matching segments of x and h term-by-term. For example, FIG. 2 shows the input data x split into two streams x₁ and x₂, so there is a first filter h₁ 208 for filtering the first transformed stream \hat{x}₁ and a second filter h₂ 210 for filtering the second transformed stream \hat{x}₂. In other words, the first filter 208 may multiply the transformed data stream \hat{x}₁ by the first portion of the transformed filter function ĥ₁, and the second filter 210 may multiply the transformed data stream x₂ by the second portion of the transformed filter function ĥ₂. Another option in the FFTpc algorithm 204 is whether to output a vector with the correct magnitude of the transform or to output the exact transform values; for the filter function h, the output is the exact transform. One reason for obtaining the exact values (with exact phase) for the filter function h (i.e., using the with-rotation option) is that usually the same filter function h is used for many inputs x, so it is usually more computationally efficient to find the exact-phase values for the filter function h than for each input x.

In the one-dimensional example given above, assume the following filter function, which is real-valued and symmetrical about the middle (bolded):

$$h = [ \begin{matrix}2.1113 & 1.2457 & 0.90609 & 1.6044 & - 4.5245 & 1.6044 & 0.90609 & 1.2457\end{matrix} ]$$

The FFTpc of this filter h (which is the same as the standard FFT of h) is also symmetrical about the middle:

$${\hat{h}}_{s} = [ \begin{matrix}5.0992 & 6.1285 & - 4.2253 & 7.1429 & - 6.3012 & 7.1429 & - 4.2253 & 6.1285\end{matrix} ]$$

However, the final permutation in the FFTpc algorithm 204 is omitted, and the odd values of ĥₛ are listed first, and then the even values of ĥₛ are listed next, such that the resulting FFTpc transform of the filter is:

$$\hat{h} = [ \begin{matrix}5.0992 & - 42253 & - 6.3012 & - 4.2253 & 6.1285 & 7.1429 & 7.1429 & 6.1285 ]\end{matrix}$$

Taking the first half of ĥ:

$${\hat{h}}_{1} = [ \begin{matrix}5.0992 & - 4.2253 & - 6.3012 & - 4.2253\end{matrix} ]$$

the output of the first filter 208 is the term-by-term product of the transformed data stream \hat{x}₁ and the first portion of the transformed filter function ĥ₁:

$$\begin{matrix}\hat{{x}_{1}} \cdot {\hat{h}}_{1} = [ \begin{matrix}39 \cdot 5.0992 & ( 22 + 3 i ) \cdot - 4.2253 & 5 \cdot - 6.3012 & ( 22 ‐ 3 i ) \cdot - 4.2253 ]\end{matrix} \\ = [ \begin{matrix}198.87 & - 92.957 - 12.676 i & - 31.506 & - 92.957 + 12.6 \; 76 i ]\end{matrix}\end{matrix}$$

With continued reference to FIG. 2, the system 200 may next take the transformed filtered data and transform it back into the time domain through the “reverse FFTpc algorithm” 212. See also the above-disclosed U.S. Pat. No. 9,298,674.

In the one-dimensional example given above, with the input to the reverse FFTpc algorithm 212 being \hat{x}₁·ĥ₁=[198.87 −92.957 −12.676i −31.506−92.957+12.676i], the output y₁ is also a size-4 vector. The algorithm 212 first performs the sumdiff function on the input to generate a first temporary vector temp₁:

$$\begin{matrix}{temp}_{1} = \begin{matrix}[ 198.87 - 31.506 & - 92.957 - 12.676 i - 92.957 - 12.676 i \\ 198.87 + 31506 - 92.95712 \text{.676} i + 92.95712 \text{.676} i ]\end{matrix} \\ = [ \begin{matrix}167.364 - 185.914 & 230.376 & - 25.352 i ]\end{matrix}\end{matrix}$$

The algorithm 212 next performs the sumdiff function on the third and fourth values of temp₁ to generate a second temporary vector temp₂:

$${temp}_{2} = [ \begin{matrix}230. 3 \; 76 - 25.352 i & 230.376 + 25.352 i ]\end{matrix}$$

The algorithm 212 next calculates the output y₁ with its entries being:

$$\begin{matrix}Positions 1 and 3 = sumdiff ( positions 1 and 2 of {temp}_{1} ) / 4 \\ Position 2 = ( ( position 1 of {temp}_{2} ) - ( position 2 of {temp}_{2} ) \cdot i ) \cdot ( 1 + i ) / 8 \\ Position 4 = ( ( position 1 of {temp}_{2} ) - ( position 2 of {temp}_{2} ) \cdot i ) \cdot ( 1 + i ) / 8\end{matrix}$$

namely,

$$\begin{matrix}Position 1 of {y}_{1} = ( 167.364 - 185.914 ) / 4 = - 4.6378 \\ \begin{matrix}Position 2 of {y}_{1} = ( ( 23 \; 0.376 - 25.352 i ) - ( 230.376 + 25.352 i ) \cdot i ) \cdot ( 1 + i ) / 8 \\ = ( 230.376 - 25.352 i - 230.376 i - 25.352 {i}^{2} ) \cdot ( 1 + i ) / 8 \\ = ( 255.728 - 255.728 i ) \cdot ( 1 + i ) / 8 = 255.728 \cdot ( 1 - i ) \cdot ( 1 + i ) / 8 \\ = 255.728 \cdot 2 / 8 = 63.932\end{matrix} \\ Position 3 of {y}_{1} = ( 167.364 - 185.914 ) / 4 = 88.32 \\ \begin{matrix}Position 4 of {y}_{1} = ( ( 23 \; 0.376 - 25.352 i ) - ( 230.376 + 25.352 i ) \cdot i ) \cdot ( 1 + i ) / 8 \\ = ( 230.376 - 25.352 i - 230.376 i - 25.352 {i}^{2} ) \cdot ( 1 + i ) / 8 \\ = ( 205.024 + 205.024 i ) \cdot ( 1 - i ) / 8 = 205.024 \cdot ( 1 + i ) \cdot ( 1 - i ) / 8 \\ = 205.024 \cdot 2 / 8 = 51.256\end{matrix} \\ such that {y}_{1} = [ \begin{matrix}- 4.6378 & 63.932 & 88.32 & 51.256 ]\end{matrix}\end{matrix}$$

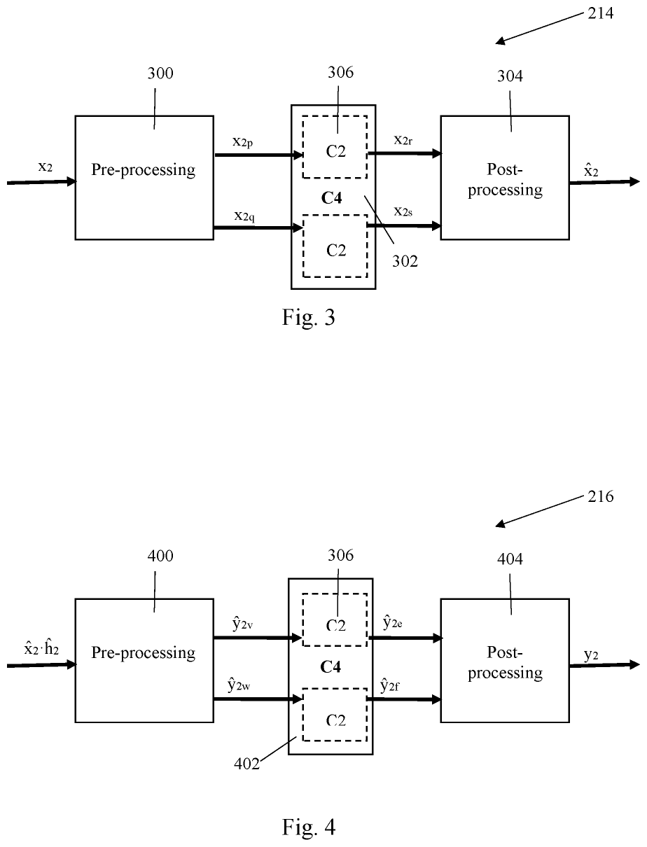

With continued reference to FIG. 2, and turning now to the second data stream x₂, it may be processed by the “parallel DCTs (pDCTs) algorithm” 214 that includes the discrete cosine transform (DCT). This algorithm 214 is diagrammed in further detail in FIG. 3. The pDCTs algorithm 214 may first include a pre-processing algorithm 300 that takes the input stream x₂ and applies the “diffsumflip” function. In its generalized form “diffsumflip(a, b),” it takes inputs a and b and generates two outputs p and q, the first of which is flip(a)+b and the second of which is a −flip(b), where “flip(x)” reverses the order of the entries in x. In the pre-processing algorithm 300, the data stream x₂ is separated into a first half x₂ₐ and a second half x_{2b} to be the inputs of the diffsumflip function, the outputs of which are x₂ₚ and x_{2q}.

In the one-dimensional example given above, with the input to the pre-processing algorithm x₂=[−20 7 −4 −2], then:

$$\begin{matrix}{X}_{2 a} = [ \begin{matrix}- 20 & 7\end{matrix} ] \\ {X}_{2 b} = [ \begin{matrix}- 4 & - 2\end{matrix} ] \\ flip ( {X}_{2 a} ) = [ \begin{matrix}7 & 20\end{matrix} ] \\ flip ( {X}_{2 b} ) = [ \begin{matrix}- 2 & - 4\end{matrix} ] \\ {X}_{2 p} = [ \begin{matrix}7 - 4 & - 20 - 2\end{matrix} ] = [ \begin{matrix}3 & - 22\end{matrix} ] \\ {X}_{2 q} = [ \begin{matrix}- 20 + 2 & 7 + 4\end{matrix} ] = [ \begin{matrix}- 18 & 11\end{matrix} ]\end{matrix}$$

With continued reference to FIG. 3, the pre-processed data x₂p and x₂q may then be processed by the “DCT type four (DCT-IV or C4) algorithm” 302 to output transformed data x₂ᵣ and x₂ₛ, respectively. For a vector x of length n, the C4 function is defined by:

$$C 4 ( k ) = {\sum }_{m = 0}^{n - 1} x ( m ) [ cos [ \frac{π}{n} ( m + 1 / 2 ) ( k + 1 / 2 ) ] ]$$

for k=0 to n −1. This definition involves no complex variables, unlike the Fourier transform of a vector, and thus the C4 algorithm 302 does not require the multiplication of complex numbers, unlike the standard FFT, and thus saves many floating-point operations. Similar to the above-discussed sumdiff operator, C4 also has a self-inverse property:

$$C 4 ( C 4 ( x ) ) = ( n / 2 ) \cdot x$$

where n is the length of x. Because n must be a power of 2, the n/2 term will be a bit-shift operation in binary arithmetic, similar to the sumdiff operation. This self-inverse property means that the same transform can be applied to obtain the inverse (see reverse pDCTs algorithm 216 below) without the need to compute separate forward and inverse transforms as there would be for standard FFT.

With continued reference to FIG. 3, to compute the C4 of the outputs of the pre-processing algorithm 300, the C4 algorithm 302 may use parallel applications of the “DCT type two (DCT-II or C2) algorithm” 306 in one embodiment. One method of computing the C4 using parallel C2s is disclosed in G. Plonka and M. Tashe's “Fast and numerically stable algorithms for discrete cosine transforms,” published in Linear Algebra and its Applications, vol. 394, pp. 309-345 (2005), incorporated herein by reference. This C4 algorithm 302 applies the C2 algorithm 306 to x₂ₚ, resulting in x₂ᵣ. The C4 algorithm 302 likewise applies the identical C2 algorithm 306 to x_{2q} in parallel, resulting in x₂ₛ. Any constants (including trigonometric constants) needed for the C4 or C2 operations can be computed either by the pre-processing algorithm 300 or the C4 algorithm 302.

Using the one-dimensional example given above, with x₂ₚ=[3 −22] and x_{2q}=[−18 11], x₂ᵣ=[−5.6474 21.473] and x₂ₛ=[−12.42 −17.051]. (For ease of notation, the inputs to the C4 algorithm 302 (x₂ₚ and x_{2q}) can collectively be written as a single concatenated input (e.g., x₂ᵢₙ), and the outputs of the C4 algorithm 302 (x₂ᵣ and x₂ₛ) can collectively be written as a single concatenated output (e.g., x₂ₒᵤₜ).) In the one-dimensional example given above,

$${x}_{2 in} = [ \begin{matrix}3 & - 22 & - 18 & 11\end{matrix} ] and {x}_{2 out} = [ \begin{matrix}- 5.6474 & 21.473 & - 12.42 & - 17.051\end{matrix} ] . )$$

With continued reference to FIG. 3, the transformed data x₂ᵣ and x₂ₛ may then be processed by the post-processing algorithm 304 to result in transformed data \hat{x}₂. This algorithm 304 applies the compdsf (complex diffsumflip) operation to the inputs x₂ᵣ and x₂ₛ. In its generalized form “compdsf(a, b)” it takes inputs a and b and generates two outputs t and u, the first of which is a +b·i and the second of which is flip(a −b·i). The post-processing algorithm 304, then concatenates the two outputs of the compdsf function to form \hat{x}₂.

In the one-dimensional example given above, with the inputs to the post-processing algorithm x₂ᵣ=[−5.6474 21.473] and x₂ₛ=[−12.42 −17.051], then:

$$\begin{matrix}{x}_{2 t} = [ \begin{matrix}- 5.6474 - 12.42 i & 21.473 - 17.051 i ]\end{matrix} \\ a - bi = [ \begin{matrix}- 5.6474 + 12.42 i & 21.473 + 17.051 i\end{matrix} ] \\ {x}_{2 u} = [ \begin{matrix}21.473 + 17.0 \; 51 i & - 5.6474 + 12.42 i\end{matrix} ] \\ {\hat{x}}_{2} = [ \begin{matrix}- 5.6474 - 12.42 i & 21.473 - 17.051 i & 21.473\end{matrix} + 17.051 i - 5.6474 + 12.42 i ]\end{matrix}$$

Returning to FIG. 2, the transformed output \hat{x}₂ of the pDCTs algorithm 214 may then be filtered, as described above. In the one-dimensional example given above, the second half of ĥ is:

ĥ₂=[6.1285 7.1429 7.1429 6.1285]

and the output of the second filter 210 is the term-by-term product of the transformed data stream \hat{x}₂ and the second portion of the transformed filter function ĥ₂:

$$\begin{matrix}{\hat{x}}_{2} \cdot {\hat{h}}_{2} = \begin{matrix}[ ( - 5.6474 - 12.42 i ) \cdot 6.1285 & ( 21.473 - 17. 051 i ) \cdot 7.1429 & ( 21.473 + 17.051 i ) \cdot 7.1429 ( - 5.6474 + 12.42 i ) \cdot 6.1285 ]\end{matrix} \\ = [ - 34 \text{.61} - 76. 118 i153 \text{.38} - 121.79 i 153.38 + 121.79 i - 34.61 + 76.116 i ]\end{matrix}$$

With continued reference to FIG. 2, the system 200 may next take the transformed filtered data \hat{x}₂·ĥ₂ (which may also be thought of as ŷ₂) and transform it back into the time domain through the “reverse pDCTs algorithm” 216. This algorithm is diagrammed in further detail in FIG. 4. The reverse pDCTs algorithm 216 may first include a pre-processing algorithm 400 that takes the transformed filtered data \hat{x}₂·ĥ₂ and applies the revcompdsf (reverse complex diffsumflip) operation to it, to undo the compdsf function that was applied by the post-processing algorithm 304. In its generalized form “revcompdsf(c, d),” it takes inputs c and d and generates two outputs v and w, the first of which is [c+flip(d)]/2 and the second of which is [c −flip(d)]·−i/2. The revcompdsf operation is the inverse of the compdsf operation, so revcompdsf(compdsf(x))=x. In the pre-processing algorithm 400, the data stream \hat{x}₂·ĥ₂ is separated into a first half ŷ_{2c} and a second half ŷ_{2d} to be the inputs of the revcompdsf function, the outputs of which are ŷ₂ᵥ and ŷ_{2w}.

In the one-dimensional example given above, with the input to the pre-processing algorithm \hat{x}₂·ĥ₂=[−34.61−76.118i 153.38−121.79i 153.38+121.79i −34.61+76.116i], then:

$$\begin{matrix}{\hat{y}}_{2 c} = [ \begin{matrix}- 34.61 - 76. 1 \; 18 i & 153.38 - 121.79 i\end{matrix} ] \\ {\hat{y}}_{2 d} = [ \begin{matrix}153.38 + 121.79 i & - 34.61 + 76.116 i ]\end{matrix} \\ flip ( {\hat{y}}_{2 d} ) = [ \begin{matrix}- 34. 61 + 76.1 \; 18 i & 153.38 + 121.79 i\end{matrix} ] \\ {\hat{y}}_{2 v} = [ \begin{matrix}- 34.61 - 76. 118 i - 34.61 + 76.1 \; 18 i & 153.38 - 121.79 i + 153.38 + 121.79 i\end{matrix} ] / 2 \\ = [ \begin{matrix}- 69.22 & 306.76\end{matrix} ] / 2 = [ \begin{matrix}- 34.61 & 153.38\end{matrix} ] \\ {\hat{y}}_{2 w} = [ \begin{matrix}- 34.61 - 76. 118 i + 34 \text{.61} - 76. 1 \; 18 i & 153.38 - 121.79 i - 153.38 - 121.79 i\end{matrix} ] \cdot - i / 2 \\ = [ \begin{matrix}- 152.236 i & - 243.58 i\end{matrix} ] \cdot - i / 2 = [ \begin{matrix}- 76.1 \; 18 & - 121.79\end{matrix} ]\end{matrix}$$

With continued reference to FIG. 4, the pre-processed data ŷ₂ᵥ and ŷ_{2w} may then be processed by the inverse C4 algorithm 402 to output data ŷ₂ₑ and ŷ_{2f}. As explained above, this algorithm 402 is the same as the C4 algorithm 302 due to its self-inverse property. This algorithm 402 may also use parallel applications of the C2 algorithm 306. The C2 algorithm 306 may be applied to ŷ₂ᵥ to produce ŷ₂ₑ, while the identical C2 algorithm 306 may be applied in parallel to ŷ_{2w} to produce ŷ_{2f}. (For ease of notation, the inputs to the C4 algorithm 402 (ŷ₂ᵥ and ŷ_{2w}) can collectively be written as a single concatenated input (e.g., ŷ₂ᵢₙ), and the outputs of the C4 algorithm 402 (ŷ₂ₑ and ŷ_{2f}) can collectively be written as a single concatenated output (e.g., ŷ₂ₒᵤₜ).) Using the one-dimensional example given above, with ŷ₂ᵥ=[−34.61 153.38] and ŷ_{2w}=[−76.118 −121.79], ŷ₂ₑ=[26.722 −154.95] and ŷ_{2f}=[−116.93 83.394]. Using the simplified notation, ŷ₂ᵢₙ=[−34.61 153.38 −76.118 −121.79] and ŷ₂ₒᵤₜ=[26.722 −154.95 −116.93 83.394].

With continued reference to FIG. 4, the transformed data ŷ₂ₑ and ŷ_{2f} may then be processed by the post-processing algorithm 404 to result in data y₂. This algorithm 404 computes diffsumflip(ŷ₂ₑ, ŷ_{2f}), which operation was discussed above, and the result is divided by a certain divisor that is a power of 2 (i.e., a bit shift) to produce outputs y₂ₑ and y_{2f}, which are concatenated to result in data y₂. If the input x is of length 8, then this divisor is 2. If the input x is of a greater length (e.g., size−32), then the divisor is half the size of the parallel stream being processed by algorithm 404 (i.e., np/2, where np is the length of the stream). For example, if x is size−32 and is split into four streams (x₁ is size−4, x₂ is size−4, x₃ is size−8, and x₄ is size−16), then for the three filtered streams processed by the reverse pDCTs algorithm 216 (further discussed below), the divisor in the post-processing algorithm 404 is 2 for \hat{x}₂·ĥ₂, 4 for \hat{x}₃·ĥ₃, and 8 for \hat{x}₄·ĥ₄. In the one-dimensional example given above:

$$\begin{matrix}{\hat{y}}_{2 e} = [ \begin{matrix}26.7 22 & - 154.95\end{matrix} ] \\ {\hat{y}}_{2 f} = [ \begin{matrix}- 116 \text{.93} & 83.394\end{matrix} ] \\ flip ( {\hat{y}}_{2 e} ) = [ \begin{matrix}- 154 \text{.95} & 26.722\end{matrix} ] \\ flip ( {\hat{y}}_{2 f} ) = [ \begin{matrix}83.394 & - 116.93\end{matrix} ] \\ {y}_{2 e} = [ \begin{matrix}- 154 \text{.95} - 11 \; 6 \text{.93} & 26.722 + 83.394\end{matrix} ] / 2 = [ \begin{matrix}- 271.88 & 110.116\end{matrix} ] / 2 = [ \begin{matrix}- 135.94 & 55.058\end{matrix} ] \\ {y}_{2 f} = [ \begin{matrix}26.7 22 - 83.394 & - 154.95 + 116.93 ]\end{matrix} / 2 = [ \begin{matrix}- 56. 6 \; 72 & - 38.02\end{matrix} ] / 2 = [ \begin{matrix}- 28.336 & - 19.01\end{matrix} ] \\ {y}_{2} = [ \begin{matrix}- 135.94 & 55.058 & - 28.336 & - 19.01\end{matrix} ]\end{matrix}$$

With continued reference to FIG. 2, after the filtered data portions or streams y₁ and y₂ have been transformed back into the time domain, they may be combined by the mixer algorithm 218, which essentially undoes or reverses the operations of the splitter algorithm 202 and its sdvec vector. The mixer algorithm 218 calculates output data y by performing sumdiff(y₁, y₂)/2 and concatenating the results. In the one-dimensional example given above:

$$\begin{matrix}{y}_{1} = [ \begin{matrix}- 4.6378 & 63.932 & 88.32 & 51.256\end{matrix} ] \\ {y}_{2} = [ \begin{matrix}- 135.94 & 55.058 & - 28.336 & - 19.01 ]\end{matrix} \\ y = [ \begin{matrix}- 4.6378 - 135.94 & 63.932 + 55.058 & 88.32 - 28.336 & 51.256 + 19.01 ]\end{matrix} / 2 \\ = [ \begin{matrix}- 140. 5 \; 778 & 118.99 & 59.984 & 32.246 & 131.3022 & 8.874 & 116.656 & 70.266\end{matrix} ] / 2 \\ = [ \begin{matrix}- 70.29 & 59.495 & 29.992 & 16.123 & 65.652 & 4.4371 & 58.328 & 35.133 ]\end{matrix}\end{matrix}$$

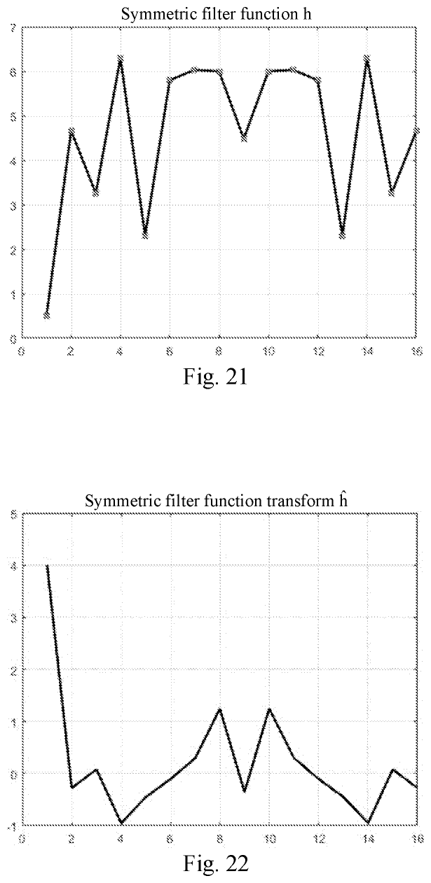

In standard filtering, frequently there are symmetry conditions on the filter function h. The filters that are most used in practice for filtering applications fall into one of the following categories: lowpass, bandpass, and highpass. For each of these filters and any others with the appropriate symmetry, the parallel filtering can be done, in an alternative embodiment, without the use of any complex variable additions or multiplications, thus making the filtering even faster because the computations are all real-valued and use no complex numbers. The appropriate symmetry restriction is that the filter function h must be real-valued and symmetric about the midpoint, not counting the first value and the midpoint+1. FIG. 21 shows an example of filter function h having the appropriate symmetry, while FIG. 22 shows the transform ĥ of the filter function h, which also exhibits a similar symmetry. For such filtering applications, the post-processing algorithm 304 may be omitted, and the outputs of the C4 algorithm 302 (e.g., x₂ᵣ and x₂ₛ in FIG. 3) may be sent directly to the filter h (e.g., the second filter 210 in FIG. 2). In the term-by-term multiplication (e.g., by the second filter 210), the two outputs of the C4 algorithm 302 are real-valued and are multiplied by exactly the same vector, which is the first half of h because of the symmetry restriction. Similarly, the pre-processing algorithm 400 may also be omitted, with the transformed filtered data sent directly to the C4 algorithm 402. This alternative embodiment may be applied to filtering in any dimension (see additional discussion below).

One advantage of the above-disclosed system 200 is that the parallel streams flow directly between the different steps or algorithms without any interchange of data between the parallel streams, which would dampen the speedup obtained from the parallel processing. Another advantage is the near-zero error in the filtering computations comparing with the result obtained using the standard FFT. For the one-dimensional example discussed above (for the size-8 input data), the norm error=2.97·10⁻¹⁴.

FIG. 2 shows the input signal x split into two parallel streams x₁ and x₂. Both streams (between the splitter algorithm 202 and the mixer algorithm 218) are of equal size, the size being half the size of the input data x. Either or both of these parallel streams can similarly be split further (e.g., x₁ can be split into x₁₁ and x₁₂, and x₂ can be split into x₂₁ and x₂₂) to create additional parallel streams and to shorten the size of each stream. The resulting split streams can be split still further and further as many times as desired. One goal of parallel computing is to distribute the computations over the number of processors available to achieve the fastest overall computation time. Another goal is to split the data so that each processor is operating on the same-sized vector. The maximum number of parallel streams depends on the size of the input data x. The smallest size that a parallel stream can have is 4, so for example if an input data x is a vector of size 32, it can be split into as many as 8 parallel streams. The number of parallel streams also depends on the number of processors available to perform the computations.

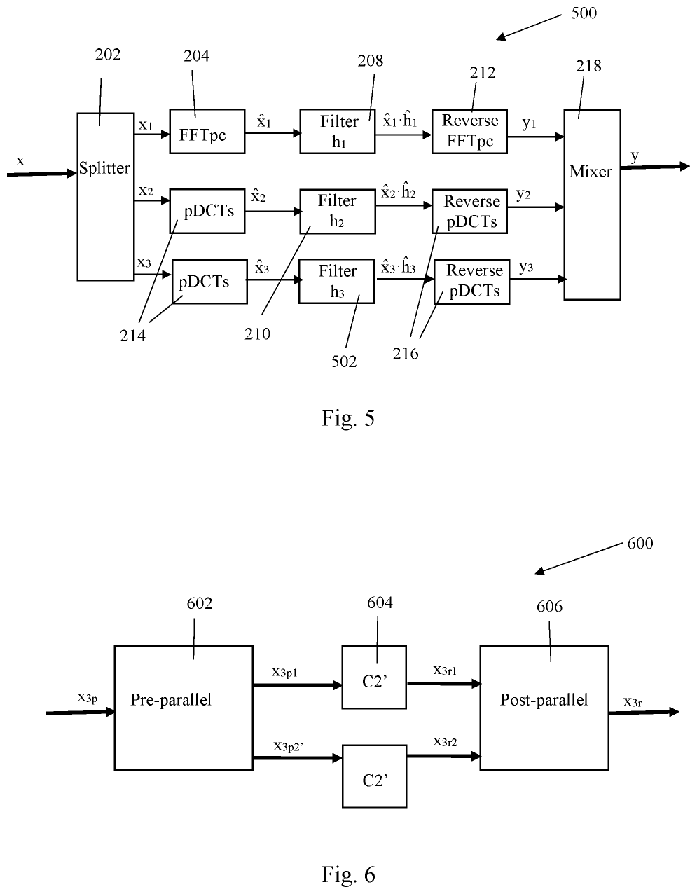

FIG. 5 shows a diagram of a filter system 500 according to another embodiment of the invention. The filter system 500 may be similar to the filter system 200 discussed above except with additional parallel streams. Specifically, FIG. 5 shows the input data x separated into three streams x₁, x₂, and x₃ using the splitter algorithm 202 discussed previously. The splitter algorithm 202 may divide sdvec into streams of the following lengths: 4, 4, 8, 16, . . . , n/2, where n is the size of the input vector x. Specifically, the first size−4 portion of sdvec is the first data stream x₁; the next size−4 portion of sdvec is the second data stream x₂; the following size−8 portion of sdvec is the third data stream x₃; and so forth. Where the size of x is n=2^{p} (where p is an integer), the number of possible parallel streams is p−1. (However some of these streams may be further divided for parallel processing as discussed below.)

As an example, if the input data x is a size−16 one-dimensional vector [4 8 6 8 9 10 2 1 7 1 5 5 9 5 4 7], then the application of the sumdiff function to compute sdvec is as follows:

$$\begin{matrix}{x}_{a} = [ \begin{matrix}4 & 8 & 6 & 8 & 9 & 10 & 2 & 1\end{matrix} ] \\ {x}_{b} = [ \begin{matrix}7 & 1 & 5 & 5 & 9 & 5 & 4 & 7\end{matrix} ] \\ {x}_{1} = [ \begin{matrix}11 & 9 & 11 & 13 & 18 & 15 & 6 & 8\end{matrix} ] \\ {x}_{2} = [ \begin{matrix}- 3 & 7 & 1 & 3 & 0 & 5 & - 2 & - 6\end{matrix} ]\end{matrix}$$

Since the concatenation of x₁ and x₂ is greater than size 4, the sumdiff function is next performed on x₁:

$$\begin{matrix}{x}_{a}^{′} = [ \begin{matrix}11 & 9 & 11 & 13 ]\end{matrix} \\ {x}_{b}^{′} = [ \begin{matrix}18 & 15 & 6 & 8 ]\end{matrix} \\ {x}_{1}^{′} = [ \begin{matrix}29 & 24 & 17 & 21 ]\end{matrix} \\ {x}_{2}^{′} = [ \begin{matrix}- 7 & - 6 & 5 & 5 ]\end{matrix}\end{matrix}$$

Since the concatenation of x₁ and x₂ is greater than size 4, the sumdiff function is next performed on x₁:

$$\begin{matrix}{x}_{a}^{″} = [ \begin{matrix}29 & 24\end{matrix} ] \\ {x}_{b}^{″} = [ \begin{matrix}17 & 21\end{matrix} ] \\ {x}_{1}^{″} = [ \begin{matrix}46 & 45\end{matrix} ] \\ {x}_{2}^{″} = [ \begin{matrix}12 & 3\end{matrix} ]\end{matrix}$$

Since the concatenation of x_{1″} and x_{2″} is not greater than size 4, sdvec is the concatenation of x_{1″}, x_{2″}, x_{2′}, and x₂, or [46 45 12 3 −7 −6 5 5 −3 7 1 3 0 5 −2 −6]. This size−16 sdvec can then be split into two equal-sized halves x₁ and x₂ and processed as discussed above with respect to FIG. 2. Alternatively, it can be split into further streams, as discussed with respect to FIG. 5, as follows: x₁ is the first size−4 portion of sdvec, [46 45 12 3]; x₂ is the next size−4 portion of sdvec, [−7 −6 5 5]; and x₃ is the next size−8 portion of sdvec, [−3 7 1 3 0 5 −2 −6]. While the examples discussed above were of size−8 and size−16, typical lengths of a one-dimensional input can be 256, 1024, or a larger power of two value.

With continued reference to FIG. 5, the parallel streams x₁ and x₂ may then be processed by the FFTpc algorithm 204 and the pDCTs algorithm 214, respectively, as discussed above with respect to FIG. 2. As for parallel stream x₃ (which is larger in size than x₁ and x₂), it can likewise be processed by the pDCTs algorithm 214 as discussed above; the same algorithm 214 can be applied to x₂ and x₃, with only the size of the processed data differing. Should the input data be large enough to be split into additional streams (e.g., x₄, x₅, etc.), those parallel streams (each of which will be of a greater size than the preceding one) can likewise be processed by the same pDCTs algorithm 214.

Alternatively, the pDCTs algorithm 214 processing stream x₃ can be modified by modifying the C2 algorithm 306 to compute even the C2 in parallel. Comparing to FIG. 3, stream x₃ may be processed by the pre-processing algorithm 300, which outputs x₃ₚ and x_{3q}, each of which are then processed by the modified parallel C2 algorithm 600 (instead of the previously disclosed C2 algorithm 306), shown in FIG. 6. The C2 algorithm 600 may include a pre-parallel algorithm 602, which separates stream x₃ₚ into two smaller parallel streams x₃ₚ₁ and x₃ₚ₂ (half the size of x₃ₚ). The pre-parallel algorithm 602 may first separate the first half of x₃ₚ into x₃ₚₐ. The algorithm 602 may then perform the flip operation on the second half of x₃ₚ to result in x_{3pb}. Again, flip(x) simply reverses the order or direction of the vector x. The algorithm 602 may then compute sumdiff(x₃ₚₐ, x_{3pb}) to result in x₃ₚ₁ and x₃ₚ₂. The algorithm 602 may then multiply x₃ₚ₂ by see((1:2:n)·π/(2n)) term by term, to result in x_{3p2′}, where (1:2:n) means the values from 1 to n in steps of 2, and n is the size of x₃ₚ.

With continued reference to FIG. 6, the parallel streams x₃ₚ₁ and x₃ₚ₂; may then each be processed by the C2′ algorithm 604. One method of computing the C2 using parallel C2′ algorithms 604 follows from Theorem 4.2 of the above-referenced G. Plonka and M. Tashe's “Fast and numerically stable algorithms for discrete cosine transforms.” Thus the C2′ algorithm 604 converts stream x₃ₚ₁ into stream x₃ᵣ₁, and converts stream x_{3p2′} into stream x₃ᵣ₂.

With continued reference to FIG. 6, the modified C2 algorithm 600 may then include a post-parallel algorithm 606 that combines the parallel streams x₃ᵣ₁ and x₃ᵣ₂ into x₃ᵣ. The algorithm 606 may take x₃ᵣ₂ and create a vector x_{3r2′} as follows. The first entry of x_{3r2′} is the first entry of x₃ᵣ₂ multiplied by √2, plus the second entry of x₃ᵣ₂. In other words: x₃ᵣ₂,(1)=\sqrt{2}x₃ᵣ₂(1)+x₃ᵣ₂(2). The second entry of x_{3r2′} is the second entry of x₃ᵣ₂ plus the third entry of x₃ᵣ₂. The third entry of x_{3r2′} is the third entry of x₃ᵣ₂ plus the fourth entry of x₃ᵣ₂, and so on until the n−1 entry of x_{3r2′}. In other words: x₃ᵣ₂,(i)=x₃ᵣ₂(i)+x₃ᵣ₂(i+1) for i from 2 to n−1, where n is the size of x₃ᵣ₂. The last entry (i=n) of x_{3r2′} is unchanged (i.e., is the nth entry of x₃ᵣ₂). The algorithm 606 may then take x₃ᵣ₁ and place its entries into the odd entries of x₃ᵣ. The algorithm 606 may then take x_{3r2′} and place its entries into the even entries of x₃ᵣ.

With continued reference to FIG. 5, after the stream x₃ has been converted into the frequency domain stream \hat{x}₃ by the pDCTs algorithm 214, it can be filtered as discussed above. Specifically, stream \hat{x}₃ can be filtered by a third filter h₃ 502, which may multiply the stream \hat{x}₃ by the third portion of the transformed filter function ĥ₃ (which was obtained with the FFTpc algorithm 204 using the exact-phase option).

With continued reference to FIG. 5, the transformed filtered data \hat{x}₃·ĥ₃ can then be transformed back into the time domain through the reverse pDCTs algorithm 216 discussed previously. Where there are eight or more parallel streams of the same size, then instead of applying the C2 algorithm 306 discussed above, the DCT type three (DCT-III or C3) algorithm may be applied instead. The C3 function is the inverse of the C2 function.

With continued reference to FIG. 5, the mixer algorithm 218 may then combine all of the time-domain data streams y₁, y₂, and y₃ (and any additional data streams (such as y₄, y₅, etc.) if the input data x is of a sufficiently large size) into output data y. The mixer algorithm 218 may order the data streams from the smallest size to the largest size. As discussed above, the algorithm 218 may perform the operation sumdiff(y₁, y₂)/2 to generate vector xfilt. If there are additional streams (e.g., y₃), then append the subsequent stream to the existing xfilt and perform the sumdiff operation (i.e., sumdiff(xfilt, y₃)/2) and make the result the updated xfilt. Continue repeating such iterations (i.e., sumdiff(xfilt, yᵢ)/2) until all of the streams have been combined. The resulting latest xfilt will be the output data y and will be of the same size n as the input data x.

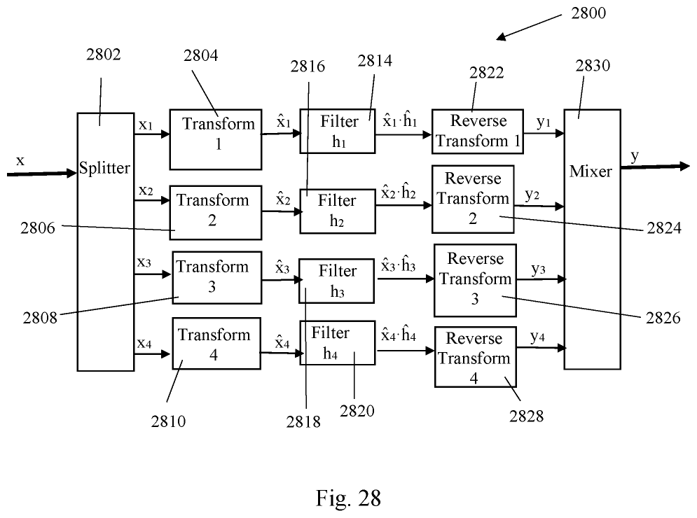

FIG. 28 shows a diagram of a filter system 2800 according to another embodiment of the invention. The filter system 2800 may be similar to the filter system 200 and filter system 500 discussed above with some modifications. Specifically, FIG. 28 shows the input data x separated into four streams x₁, x₂, x₃, and x₄ using the splitter algorithm 2802. The splitter algorithm 2802 is similar to the previously discussed splitter algorithm 202 with some modifications. Specifically, after the splitter algorithm 2802 calculates sdvec (as discussed above), it may separate sdvec into equal-sized streams. In one embodiment, algorithm 2802 may separate sdvec into as many streams as there are processors to perform the parallel processing. Using the above-disclosed example of a size−16 input vector x=[4 8 6 8 9 10 2 1 7 1 5 5 9 5 4 7], and its sdvec=[46 45 12 3 −7 −6 5 5 −3 7 1 3 0 5 −2 −6], the splitter algorithm 2802 may separate sdvec into four equal-sized streams (each of size−4):

$$\begin{matrix}{x}_{1} = [ \begin{matrix}46 & 45 & 12 & 3\end{matrix} ] \\ {x}_{2} = [ \begin{matrix}- 7 & - 6 & 5 & 5\end{matrix} ] \\ {x}_{3} = [ \begin{matrix}- 3 & 7 & 1 & 3\end{matrix} ] \\ {x}_{4} = [ \begin{matrix}0 & 5 & - 2 & - 6\end{matrix} ]\end{matrix}$$

In this example, streams x₁ and x₂ are the same as in the example discussed above with regard to FIG. 5.

With continued reference to FIG. 28, the parallel streams x₁, x₂, x₃, and x₄ may then be processed by the transform algorithms 2804, 2806, 2808, 2810, respectively. These algorithms are named generically because they may apply either the FFTpc algorithm 204 or the pDCTs algorithm 214 or both algorithms 204, 214 to their respective streams, as appropriate. Specifically, the first size−4 portion of sdvec (sdvec(1:4)) is processed by the FFTpc algorithm 204, while all other portions of sdvec (sdvec(5:n), where n is the size of x) are processed by the pDCTs algorithm 214.

In the size−16 example disclosed above, the size−4 stream x₁ is processed by the transform algorithm 2804, which executes the FFTpc algorithm 204 on the stream. The size−4 stream x₂ is processed by the transform algorithm 2806, which executes the pDCTs algorithm 214 on the stream. The size−4 stream x₃ is processed by the transform algorithm 2808, which also executes the pDCTs algorithm 214 on the stream. And the size−4 stream x₄ is processed by the transform algorithm 2810, which also executes the pDCTs algorithm 214 on the stream.

In another example, if the input data x is size−128, then its sdvec is the concatenation of a size−4 portion (sdvec(1:4)), another size−4 portion (sdvec(5:8)), a size−8 portion (sdvec(9:16)), a size−16 portion (sdvec(17:32), a size−32 portion (sdvec(33:64), and a size−64 portion (sdvec(65:128)). If sdvec were desired to be separated into four equal-sized streams (e.g., because there are four parallel processors), each stream (x₁, x₂, x₃, and x₄) would be size−32. Namely, x₁ includes the first four portions making up sdvec (sdvec(1:32)), x₂ includes the fifth portion making up sdvec (sdvec(33:64)), x₃ includes the first half of the sixth portion making up sdvec (sdvec(65:96)), and x₄ includes the second half of the sixth portion making up sdvec (sdvec(97:128)). Streams x₂, x₃, and x₄ are processed by transform algorithms 2806, 2808, 2810, respectively. Stream x₂ is processed by the transform algorithm 2806, which executes the pDCTs algorithm 214 on it. Streams x₃ and x₄ are the first and second halves of the diffsumflip operation (of the pre-processing algorithm 300 of the pDCTs algorithm 214, as discussed above), and each of these streams are processed directly by a C4 algorithm 302 (of the pDCTs algorithm 214, as discussed above). In contrast, stream x₁ is processed by transform algorithm 2804, which executes the FFTpc algorithm 204 on the first size−4 portion of x₁ (x₁(1:4)), and executes the pDCTs algorithm 214 on the remaining portions of x₁ (x₁(5:8), x₁(9:16), and x₁(17:32)). The algorithm 2804 then concatenates the outputs of these computations to produce transformed stream \hat{x}₁.

With continued reference to FIG. 28, the transformed data may then be filtered, as discussed above. To recap, the filter transform h may be split into as many components as there are parallel data streams, so that the subvectors of ĥ (e.g., ĥ₁, ĥ₂, etc.) are set up to match with the parallel streams of \hat{x} (e.g., \hat{x}₁, \hat{x}₂, etc.) for the term-by-term product. The filter system 2800 may then multiply the matching segments of \hat{x} and ĥ term-by-term. In the example shown in FIG. 28, stream x₁ is filtered by a first filter 2814 (by multiplying \hat{x}₁ by ĥ₁), stream x₂ is filtered by a second filter 2816 (by multiplying \hat{x}₂ by ĥ₂), stream x₃ is filtered by a third filter 2818 (by multiplying \hat{x}₃ by ĥ₃), and stream x₄ is filtered by a fourth filter 2820 (by multiplying \hat{x}₄ by ĥ₄).

With continued reference to FIG. 28, the transformed filtered data can then be transformed back into the time domain through the reverse transform algorithms 2822, 2824, 2826, 2828. These algorithms 2822, 2824, 2826, 2828 are named generically because they may apply either the reverse FFTpc algorithm 212 or the reverse pDCTs algorithm 216 or both algorithms 212, 216 to their respective streams, as appropriate. Specifically, the first size−4 portion of \hat{x}₁·ĥ₁ (also known as ŷ₁) (ŷ₁(1:4)) is processed by the reverse FFTpc algorithm 212, while all other portions of ŷ₁, as well as all other streams (ŷ₂, ŷ₃, etc.), are processed by the reverse pDCTs algorithm 216.

In the size−16 example disclosed above, the size−4 stream ŷ₁ is processed by the reverse transform algorithm 2822, which executes the reverse FFTpc algorithm 212 on the stream. The size−4 stream ŷ₂ is processed by the reverse transform algorithm 2824, which executes the reverse pDCTs algorithm 216 on the stream. The size−4 stream ŷ₃ is processed by the reverse transform algorithm 2826, which also executes the reverse pDCTs algorithm 216 on the stream. And the size−4 stream ŷ₄ is processed by the transform algorithm 2828, which also executes the reverse pDCTs algorithm 216 on the stream.

In the size−128 example disclosed above, the size−32 streams ŷ₂, ŷ3, and ŷ₄ are processed by the reverse transform algorithms 2824, 2826, 2828, respectively, each of which executes the reverse pDCTs algorithm 216 on the respective stream to produce streams y₂, y₃, and y₄, respectively. In contrast, stream ŷ₁ is processed by the reverse transform algorithm 2822, which executes the reverse FFTpc algorithm 212 on the first size−4 portion of ŷ₁ (ŷ₁(1:4)), and executes the reverse pDCTs algorithm 216 on the remaining portions of ŷ₁ (ŷ₁(5:8), ŷ₁(9:16), and ŷ₁(17:32)). The algorithm 2822 then concatenates the outputs of these computations to produce transformed stream y₁.

With continued reference to FIG. 28, after the filtered data streams y₁, y₂, y₃, and y₄ have been transformed back into the time domain, they may be combined by the mixer algorithm 2830, which essentially undoes or reverses the operations of the splitter algorithm 2802. The mixer algorithm 2830 is similar to the previously discussed mixer algorithm 218 with some modifications. Specifically, before performing the algorithm's 218 sumdiff/2 operations discussed above with respect to FIG. 5, the mixer algorithm 2830 first concatenates all of its inputs (y₁, y₂, y₃, and y₄ in FIG. 28) from which it then ascertains the data portions (corresponding to sdvec) from the smallest size to the largest, on which it 2830 then performs the sumdiff/2 operation(s) discussed above with respect to algorithm 218.

In the size−16 example disclosed above, streams y₁, y₂, y₃, and y₄ are each size−4. The mixer algorithm 2830 thus concatenates these streams and ascertains that y₁ and y₂ form the first portions (each of size−4) on which the sumdiff/2 operation is performed to generate xfilt (of size−8). Then, the sumdiff/2 operation is performed on xfilt and the combination of y₃ and y₄, which together form the remaining portion (size−8), with the result being the updated xfilt (now of size−16). There being no additional streams, the most current xfilt is thus output data y.

In the size−128 example disclosed above, streams y₁, y₂, y₃, and y₄ are each size−32. The mixer algorithm 2830 thus performs the sumdiff/2 operation on y₁(1:4) and y₁(5:8) to generate xfilt (of size−8). The mixer algorithm 2830 then performs the sumdiff/2 operation on xfilt and y₁(9:16), with the result being the updated xfilt (now of size−16). The mixer algorithm 2830 then performs the sumdiff/2 operation on xfilt and y₁(17:32), with the result being the updated xfilt (now of size−32). The mixer algorithm 2830 then performs the sumdiff/2 operation on xfilt and y₂ (of size−32), with the result being the updated xfilt (now of size−64). The mixer algorithm 2830 then performs the sumdiff/2 operation on xfilt and the combination of y₃ and y₄, which together form the remaining portion (of size−64), with the result being the updated xfilt (now of size−128). There being no additional streams, the most current xfilt is thus output data y.

If the input data x is complex-valued, then it can be processed as two parallel streams (one for the real part and another for the imaginary part) that are each real-valued. The filtered outputs of the two streams can simply added (namely, the real part+i·imaginary part).

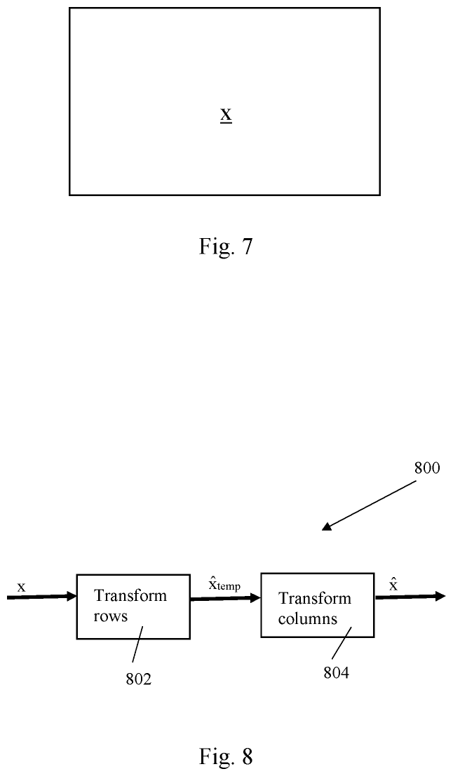

The above examples given were of one dimension (1D), but as stated above, higher-dimension data may similarly be processed in parallel. FIG. 7 shows an exemplary two-dimensional (2D) input data x that is to be filtered. Examples of such input data include photographs or other images. In 2D, the filter h may be called a mask. Normally, a 2D DFT of the data x may be obtained using the transform system 800 disclosed in FIG. 8 as follows. In the first step 802, obtain the 1D transform of each row (or column) of the input data x and place the result in the same row (or column), resulting in data \hat{x}ₜₑₘₚ. In the second step 804, obtain the 1D transform of each column (or row) of \hat{x}ₜₑₘₚ and place the result in the same column (or row), resulting in transformed data \hat{x}. For example, if input data x is an image matrix of size 2048×4096, applying a standard 2D FFT to it would require 2,048 1D row transforms (each of size 4,096) followed by 4,096 1D column transforms (each of size 2,048). This large amount of computation can be reduced significantly by the parallel filtering algorithm disclosed herein. Since a 2D transform of an image consists of 1D transforms of its rows and columns, 2D filtering in parallel is similar to the 1D parallel filtering method discussed above. The extension to three dimensions (3D) and higher is done similarly.

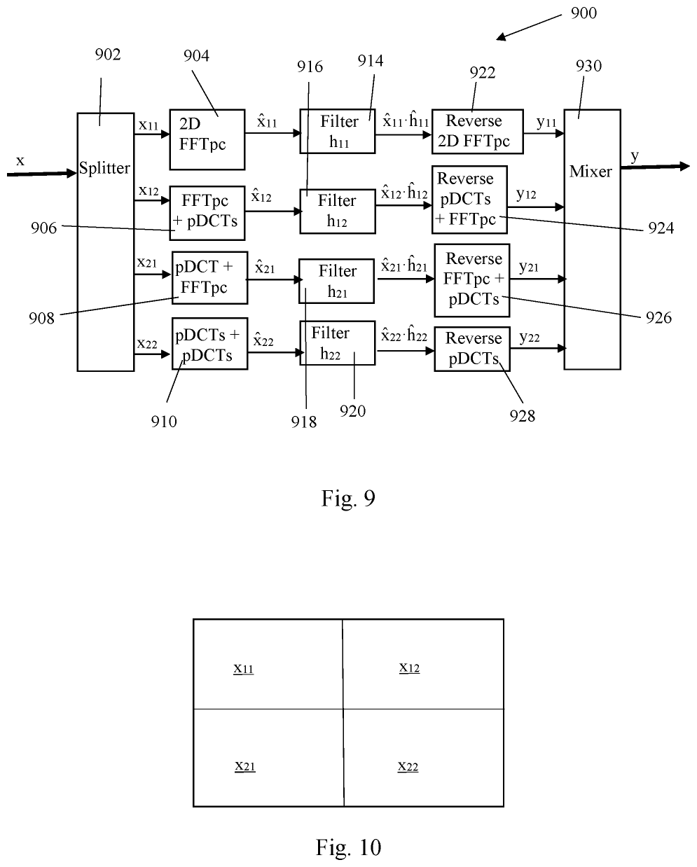

FIG. 9 shows a diagram of a filter system 900 according to one embodiment of the invention. The system may separate for parallel processing the 2D input data x into four quadrants x₁₁, x₁₂, x₂₁, and x₂₂, as shown in FIG. 10, using the splitter algorithm 902. The splitter algorithm 902 may perform a 2D sumdiff operation as follows. The first or top half of the rows of data x is called xrowsTop. The last or bottom half of the rows of data x is called xrowsBot. The algorithm 902 performs sumdiff(xrowsTop, xrowsBot) by (1) calculating xrowsTop+xrowsBot and setting the result as the top half of new matrix x_{g}, and (2) calculating xrowsTop −xrowsBot and setting the result as the bottom half of x_{g}. The left half of the columns of data x_{g} is called xgcolsLeft. The right half of the columns of data x_{g} is called xgcolsRight. The algorithm 902 then performs sumdiff(xgcolsLeft, xgcolsRight) by (1) calculating xgcolsLeft+xgcolsRight and setting the result as the left half of new matrix xₕ, and (2) calculating xgcolsLeft −xgcolsRight and setting the result as the right half of xₕ. The resulting data xₕ is analogous to sdvec discussed above, and it is xₕ that is partitioned into x₁₁, x₁₂, x₂₁, and x₂₂, as shown in FIG. 10. Alternatively, instead of first computing the rows and then the columns in the 2D sumdiff, the algorithm 902 may first compute the columns and then the rows. Additionally, the portions added or subtracted in the sumdiff operation can be switched in alternative embodiments (i.e., xrowsBot+xrowsTop and xrowsBot-xrowsTop; xgcolsRight+xgcolsLeft and xgcolsRight-xgcolsLeft), as long as the corresponding order is followed when combining or mixing the parallel subregions in the mixer algorithm 930. These sumdiff operations may be implemented in parallel since each row (or column) of x and then each column (or row) of x_{g} are independent of the others. Whereas the filter system 200 shown in FIG. 2 separated the 1D data into at least two independent parallel streams, this filter system 900 shown in FIG. 9 separates the 2D data into at least four independent parallel streams/subregions. If the input data were 3D (e.g., a magnetic resonance imaging volume), that volume could be separated by a 3D sumdiff operation into eight independent parallel streams/subvolumes.

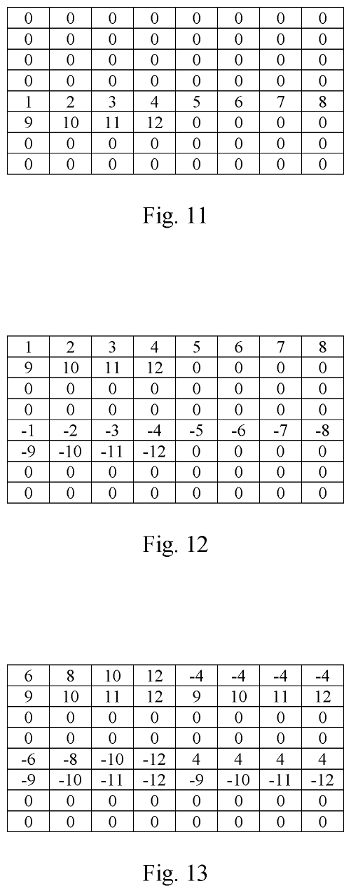

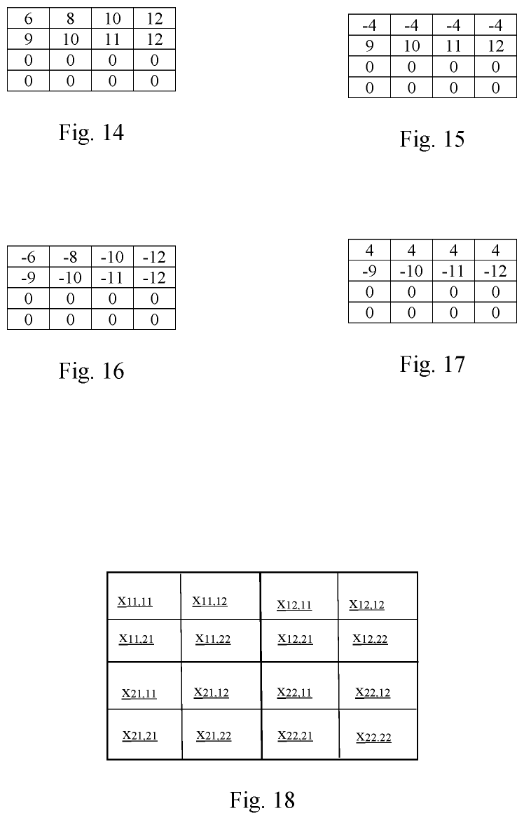

For example, if the input data x is an 8×8 matrix with the values shown in FIG. 11, then FIG. 12 shows x_{g}, which is the result of sumdiff(xrowsTop, xrowsBot) and FIG. 13 shows xₕ, which is the result of sumdiff(xgcolsLeft, xgcolsRight). The four subregions of xₕ form the parallel streams for further processing: x₁₁ (FIG. 14), x₁₂ (FIG. 15), x₂₁ (FIG. 16), and x₂₂ (FIG. 17).

With continued reference to FIG. 9, stream x₁₁ may then be processed by the 2D FFTpc algorithm 904 that first computes the 1D FFTpc on each row of x₁₁, resulting in stream \hat{x}₁₁ₜₑₘₚ. Then, the algorithm 904 computes the 1D FFTpc on each column of \hat{x}₁₁ₜₑₘₚ, resulting in stream \hat{x}₁₁. The 1D FFTpc computations are computed using the FFTpc algorithm 204 discussed above. Similar to the 1D FFTpc algorithm 204 discussed above, the 2D FFTpc algorithm 904 may in some embodiments obtain the exact value of the 2D DFT.

In other embodiments, the 2D FFTpc algorithm 904 may be performed without the complex-valued rotations at the end of the algorithm 904 (i.e., by omitting them and just obtaining the correct absolute value or magnitude) to obtain even faster processing. If this option is chosen and then the exact values (with phase) be desired, they can be obtained by adjusting the phase angles as follows. First create a matrix A of angles (in degrees) that is the same size as the input data x, the size being n₁×n₂ where n₁ and n₂ are powers of 2. Second, calculate the horizontal difference diffH=180/n₂ and the vertical difference diffV=180/n₁. Third, populate the values of matrix A as follows. A(1,1)=0. The first column A(j, 1) has the following values for its rows (after the first one): −90+(j−1) for j=2, . . . , n₁. The first row A(1,k) has the following values for its columns (after the first one): −90+(k−1) for k=2, . . . , n₂. The remaining entries of matrix A have the following values:

A(j,k)=−180+(j−1)·diffV+(k−1)·diffH

FIG. 20 shows an 8×8 matrix A. Each entry of matrix A is an adjustment phase angle φⱼₖ.

Having calculated the phase angles, then create a matrix B having the same size as matrix A. Each entry in matrix B is a complex-valued exponential function with the correct phase angle, namely:

$$B ( j , k ) = {e}^{i \cdot {φ}_{j k}}$$

Multiplying by such a function is a rotation in the complex domain. Thus, to convert from the absolute-value 2D DFT to the exact value 2D DFT, each term in the absolute-value 2D DFT is multiplied by the corresponding complex-valued exponential element in the B matrix, which is equivalent to rotating each absolute-value term by the corresponding angle. This is term-by-term multiplication. As noted above, such rotation need only be done to the 2D filter function h, and not to the image matrix x, which may be left in the form of the absolute-value matrix, thereby saving many computations.

With continued reference to FIG. 9, stream x₁₂ may then be processed by an algorithm 906 that first computes the 1D FFTpc on each row of x₁₂, resulting in stream \hat{x}₁₂ₜₑₘₚ. This 1D FFTpc computation is computed using the FFTpc algorithm 204 discussed above (with the no-rotation option). Then, the algorithm 906 computes the 1D pDCTs on each column of x₁₂ₜₑₘₚ, resulting in stream x₁₂. This 1D pDCTs computation is computed using the pDCTs algorithm 214 discussed above.

With continued reference to FIG. 9, stream x₂₁ may then be processed by an algorithm 908 that is similar to algorithm 906, except reverses the operations. Namely, algorithm 908 first computes the 1D pDCTs on each row of x₂₁, resulting in stream \hat{x}₂₁ₜₑₘₚ. This 1D pDCTs computation is computed using the pDCTs algorithm 214 discussed above. Then, the algorithm 906 computes the 1D FFTpc on each column of \hat{x}₂₁ₜₑₘₚ, resulting in stream \hat{x}₂₁. This 1D FFTpc computation is computed using the FFTpc algorithm 204 discussed above (with the no-rotation option).

With continued reference to FIG. 9, stream x₂₂ may then be processed by an algorithm 910 that (similar to algorithm 908) first computes the 1D pDCTs on each row of x₂₂, resulting in stream \hat{x}₂₂ₜₑₘₚ. Then, the algorithm 910 computes the 1D pDCTs on each column of \hat{x}₂₂ₜₑₘₚ, resulting in stream \hat{x}₂₂. The 1D pDCTs computations are computed using the pDCTs algorithm 214 discussed above.

With continued reference to FIG. 9, the transformed streams \hat{x}₁₁, \hat{x}₁₂, \hat{x}₂₁, and \hat{x}₂₂ may now be filtered. This 2D filtering may be similar to the previously discussed 1D filtering (except in two dimensions), and the component filters (914 for filter function h₁₁, 916 for filter function h₁₂, 918 for filter function h₂₁, and 920 for filter function h₂₂) and their transforms (ĥ₁₁, ĥ₁₂, ĥ₂₁, and ĥ₂₂) may likewise be computed in advance. With the filter component transforms obtained, the filter system 900 may compute the term-by-term multiplication of the transforms of the input data x and filter h for each matching subregion. In this four-stream case, \hat{x}₁₁ is multiplied by ĥ₁₁, \hat{x}₁₂ is multiplied by ĥ₁₂, \hat{x}₂₁ is multiplied by ĥ₂₁, and \hat{x}₂₂ is multiplied by ĥ₂₂.

With continued reference to FIG. 9, the filtered streams may next be converted back to the time domain. Stream \hat{x}₁₁·ĥ₁₁ may be processed by the reverse 2D FFTpc algorithm 922 to generate stream y₁₁. This algorithm 922 computes the reverse 1D FFTpc on each column of \hat{x}₁₁·ĥ₁₁, resulting in stream y₁₁ₜₑₘₚ. Then the algorithm 922 computes the reverse 1D FFTpc on each row of y₁₁ₜₑₘₚ, resulting in stream y₁₁. The reverse 1D FFTpc computation is computed using reverse FFTpc algorithm 212 discussed above.

With continued reference to FIG. 9, stream \hat{x}₁₂·ĥ₁₂ may be processed by an algorithm 924 that first computes the reverse 1D pDCTs on each column of \hat{x}₁₂·ĥ₁₂, resulting in stream y₁₂ₜₑₘₚ. This reverse 1D pDCTs computation is computed using the reverse pDCTs algorithm 216 discussed above. Then, the algorithm 924 computes the reverse 1D FFTpc on each row of y₁₂ₜₑₘₚ, resulting in stream y₁₂. This reverse 1D FFTpc computation is computed using the reverse FFTpc algorithm 212 discussed above.

With continued reference to FIG. 9, stream \hat{x}₂₁·ĥ₂₁ may then be processed by an algorithm 926 that is similar to algorithm 924, except reverses the operations. Namely, algorithm 926 first computes the reverse 1D FFTpc on each column of \hat{x}₂₁·ĥ₂₁, resulting in stream y₂₁ₜₑₘₚ. This reverse 1D FFTpc computation is computed using the reverse FFTpc algorithm 212 discussed above. Then, the algorithm 926 computes the reverse 1D pDCTs on each row of y₂₁ₜₑₘₚ, resulting in stream y₂₁. This reverse 1D pDCTs computation is computed using the reverse pDCTs algorithm 216 discussed above.

With continued reference to FIG. 9, stream \hat{x}₂₂·ĥ₂₂ may then be processed by an algorithm 928 that (similar to algorithm 924) first computes the reverse 1D pDCTs on each column of \hat{x}₂₂·ĥ₂₂, resulting in stream y₂₂ₜₑₘₚ. Then, the algorithm 928 computes the reverse 1D pDCTs on each row of y₂₂ₜₑₘₚ, resulting in stream y₂₂. The reverse 1D pDCTs computations are computed using the reverse pDCTs algorithm 216 discussed above.

As is seen from the above discussion, the parallel streams were each processed along one dimension (rows in the above discussion) and then along the other dimension (columns in the above discussion). In the above discussion, the streams were transformed into the frequency domain by first processing the rows and then the columns, while the transformation back into the time domain first processed the columns and then the rows (i.e., the reverse of the first transformation). In an alternative embodiment, the order can be switched. Namely, the streams could be transformed into the frequency domain by first processing the columns and then the rows, while the transformation back into the time domain can first process the rows and then the columns.

With continued reference to FIG. 9, the mixer algorithm 930 may then combine all of the time-domain filtered streams y₁₁, y₁₂, y₂₁, and y₂₂ into output data y, essentially undoing or reversing the operation of the splitter algorithm 902. The algorithm 930 first places the filtered streams y₁₁, y₁₂, y₂₁, and y₂₂ into a temporary matrix yₚᵣₑ having the same size as input matrix x, and where y₁₁ forms the upper left quadrant of yₚᵣₑ, y₁₂ forms the upper right quadrant of yₚᵣₑ, y₂₁ forms the lower left quadrant of yₚᵣₑ, and y₂₂ forms the lower right quadrant of yₚᵣₑ. The mixer algorithm 930 then performs a 2D sumdiff operation over yₚᵣₑ, and the result is divided by four to result in filtered output y.

Splitter algorithm 902 may create additional parallel streams by iterating the above-described process on any or all of the resulting subregions. For example, stream x₁₁ may itself be split into four independent subregions x_{11,11}, x_{11,12}, x_{11,21}, and x_{11,22} using the above-described 2D sumdiff operator on the corresponding portions of x₁₁. FIG. 18 shows the result of splitting each subregion of FIG. 10 into four further subregions (for a total of 16 parallel streams). Each set of subregions may then be processed by the set of respective algorithms 904, 906, 908, 910 and subsequent algorithms shown in FIG. 9 along the signal paths. Should still further streams be desired, each subregion can be further subdivided by a further iteration of the splitter algorithm 902, with subsequent correspondent processing.

As explained above, the splitting and parallel processing can also be done for 3D and higher dimensions. For 3D, the input data x needs to be a rectangular parallelepiped with side lengths in each direction as powers of 2. If the 3D input data were to be split in half along each dimension, this would create parallel streams x₁₁₁, x₁₁₂, x₁₂₁, x₁₂₂, x₂₁₁, x₂₁₂, x₂₂₁, and x₂₂₂. These streams may then be transformed into the frequency domain as follows. For x₁₁₁, compute the 1D FFTpc on each of the three dimensions. For x₁₁₂, compute the 1D FFTpc on the first two dimensions, and compute the 1D pDCTs on the third dimension. For x₁₂₁, compute the 1D FFTpc on the first and third dimensions, and compute the 1D pDCTs on the second dimension. For x₁₂₂, compute the 1D FFTpc on the first dimension, and compute the 1D pDCTs on the second and third dimensions. For x₂₁₁, compute the 1D FFTpc on the second and third dimensions, and compute the 1D pDCTs on the first dimension. For x₂₁₂, compute the 1D FFTpc on the second dimension, and compute the 1D pDCTs on the first and third dimensions. For x₂₂₁, compute the 1D FFTpc on the third dimension, and compute the 1D pDCTs on the first and second dimensions. For x₂₂₂, compute the 1D pDCTs on each of the three dimensions. A similar pattern may be followed for higher-dimension data.

After the frequency-domain 3D data streams have been processed by their respective component filters, the filtered frequency-domain data streams (ŷ₁₁₁, ŷ₁₁₂, ŷ₁₂₁, ŷ₁₂₂, ŷ₂₁₁, ŷ₂₁₂, ŷ₂₂₁, and ŷ₂₂₂) can be transformed back to the time-domain by reversing the above-discussed steps (to transform to the frequency domain) as follows. For ŷ₁₁₁, compute the reverse 1D FFTpc on each of the three dimensions. For ŷ₁₁₂, compute the reverse 1D pDCTs on the third dimension, and compute the reverse 1D FFTpc on the first two dimensions. For ŷ₁₂₁, compute the reverse 1D pDCTs on the second dimension, and compute the reverse 1D FFTpc on the first and third dimensions. For ŷ₁₂₂, compute the reverse 1D pDCTs on the second and third dimensions, and compute the reverse 1D FFTpc on the first dimension. For ŷ₂₁₁, compute the reverse 1D pDCTs on the first dimension, and compute the reverse 1D FFTpc on the second and third dimensions. For ŷ₂₁₂, compute the reverse 1D pDCTs on the first and third dimensions, and compute the reverse 1D FFTpc on the second dimension. For ŷ₂₂₁, compute the reverse 1D pDCTs on the first and second dimensions, and compute the reverse 1D FFTpc on the third dimension. For ŷ₂₂₂, compute the reverse 1D pDCTs on each of the three dimensions. A similar pattern may be followed for higher-dimension data.

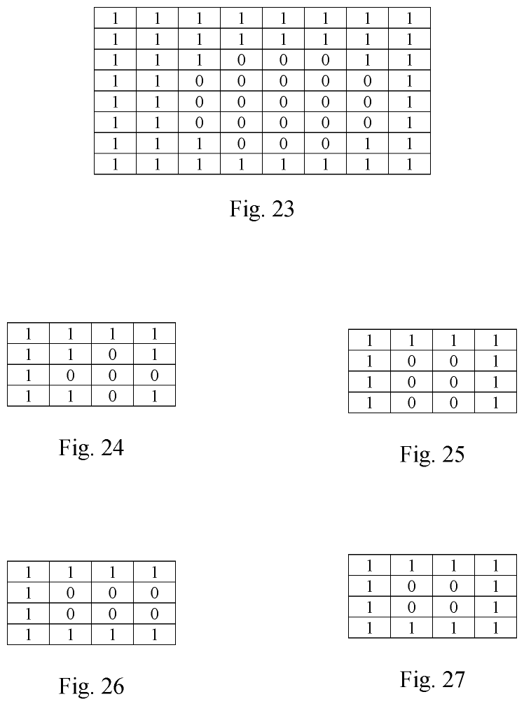

If a higher-dimension (e.g., 2D or 3D) filter is also symmetrical, then like the 1D filtering discussed above, the filtering may be done, in alternative embodiments, with real-valued numbers and without complex numbers in the computations. This applies to multidimensional filters in the lowpass, bandpass, and highpass categories, as well as any other filters that exhibit the appropriate symmetry. For the multidimensional filters, the filter mask should be adjusted before applying the component filters to the respective subregions. The adjustment is an iterative even/odd permutation or interleaving of rows and then columns. FIG. 23 shows an example 2D mask ĥ of size 8×8. A value of 1 lets the input through the filter, while a value of 0 filters out (i.e., blocks) the input at that location. This mask ĥ has the appropriate symmetry because each row is symmetric in the sense that ĥ(2:n/2)=flip(ĥ(n/2+2:n)), where n is the number of columns, and each column has the same symmetry. After the interleaving adjustment, the mask's quadrants form the filter component transforms: ĥ₁₁ (shown in FIG. 24), ĥ₁₂ (shown in FIG. 25), ĥ₂₁ (shown in FIG. 26), and ĥ₂₂ (shown in FIG. 27). These filter components involve only real-valued operations in filtering. With the appropriate symmetry of the mask, the respective post-processing algorithm 304 of the pDCTs algorithm 214 within the algorithms 906, 908, and 910 and the respective pre-processing algorithm 400 of the reverse pDCTs algorithm 216 within the algorithms 924, 926, and 928 can be omitted, which eliminates those complex-valued computations and speeds up the processing.

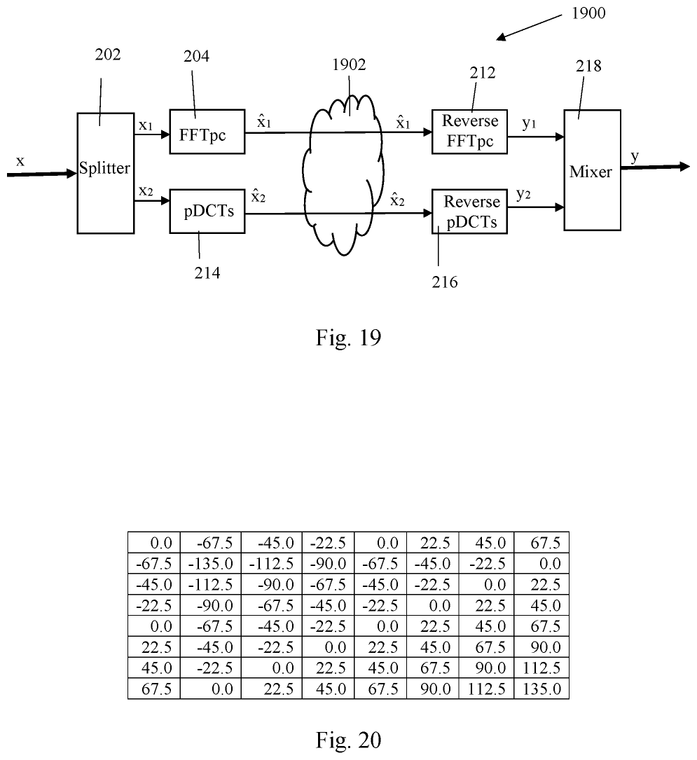

FIG. 19 shows a diagram of a transmission system 1900 according to one embodiment of the invention. The system 1900 may be similar to any filter system disclosed herein, except that it is used for transmission of the signal x (of any dimension) rather than filtering it. For convenience, the system 1900 shown in FIG. 19 is most similar to the filter system 200 shown in FIG. 2 but is not limited to only it. The transmission system 1900 can take an input signal x and split it into streams (e.g., x₁ and x₂) using the splitter algorithm 202 discussed above. The system 1900 can then convert the streams into the frequency domain using the FFTpc algorithm 204 and pDCTs algorithm 214 discussed above. The system 1900 may then transmit the frequency-domain streams (e.g., \hat{x}₁ and \hat{x}₂) through a transmission medium 1902. Examples include hard-wired cables and wirelessly with transmitters and receivers. The system 1900 may then receive the transmitted streams and convert them back into the time domain (e.g., y₁ and y₂) using the reverse FFTpc algorithm 212 and the reverse pDCTs algorithm 216 discussed above. The system 1900 may then combine the streams using the mixer algorithm 218 discussed above, resulting in signal y.

In one embodiment, the transmission system 1900 may help implement more efficiently the orthogonal frequency division multiplexing (OFDM) scheme, which is used in, e.g., the 5G communications system. Because the parallel streams are independent and flow directly from the output of a preceding algorithm into the input of the subsequent algorithm (without requiring any pre-processing), the transmission system 1900 is more efficient and faster than existing transmission systems.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A method for processing data in parallel comprising the steps of:
(a) partitioning input data into a first half and a second half;
(b) adding the first half from step (a) to the second half from step (a) term-by-term to produce a first half of a temporary vector;
(c) subtracting the second half from step (a) from the first half from step (a) term-by-term to produce a second half of the temporary vector;
(d) if the temporary vector is of size greater than 4, setting the first half of the temporary vector from step (b) as the input data and repeating steps (a)-(c), with each iteration generating a new temporary vector, until the latest temporary vector is of size 4 or less;
(e) concatenating the latest temporary vector from step (d) with each second half of the temporary vector from step (c) for all prior iterations of step (d) to form vector sdvec; and
(f) separating the sdvec from step (e) into a plurality of streams,
wherein steps (a)-(f) are performed by one or more computers.

2. The method of claim 1 further comprising the steps of:
(g) adding the first stream from the plurality of streams to the second stream from the plurality of streams term-by-term to produce a first half of a vector xfilt;
(h) subtracting the second stream from the plurality of streams from the first stream from the plurality of streams term-by-term to produce a second half of the xfilt;
(i) dividing the xfilt by 2 and setting the result as the updated xfilt; and
(j) for each remaining stream from the plurality of streams,
(1) adding xfilt from step (i) to the remaining stream term-by-term to produce a first half of the further updated xfilt;
(2) subtracting the remaining stream from xfilt from step (i) term-by-term to produce a second half of the further updated xfilt; and
(3) dividing the xfilt produced by steps (j)(1) and (j)(2) by 2 and setting the result as the further updated xfilt,
wherein the last xfilt is set as the output data.

3. The method of claim 2 further comprising steps:
(k) processing the first stream from the plurality of streams from step (f) by the FFTpc algorithm;
(l) processing each subsequent stream from the plurality of streams from step (f) by the pDCTs algorithm;
(m) processing the result of step (k) by the reverse FFTpc algorithm; and
(n) processing the result of step (l) for each subsequent stream by the reverse pDCTs algorithm,
wherein:
steps (k)-(n) are performed after step (f) and before step (g);
the streams added and subtracted in steps (g)-(h) are the results of steps (m)-(n);
the processing of each stream in steps (k)-(l) occurs in parallel; and
the processing of each stream in steps (m)-(n) occurs in parallel.

4. The method of claim 3 further comprising steps:
(o) wirelessly transmitting the outputs of steps (k)-(l) by a transmitter; and
(p) wirelessly receiving the transmitted outputs of step (o) by a receiver,
wherein steps (m)-(n) are performed on the data received in step (p).

5. The method of claim 4, wherein:
steps (a)-(f) and (k)-(l) are performed by a first computer, and
steps (g)-(j) and (m)-(n) are performed by a second computer.

6. The method of claim 3 further comprising steps:
(q) transforming a filter function into frequency domain;
(r) separating the transformed filter function from step (q) into the same number of component filters as the number of the plurality of streams from step (f); and
(s) filtering in parallel each of the plurality of streams from steps (k)-(l) by the respective component filter of step (r) by calculating their term-by-term product,
wherein steps (m)-(n) are performed on the filtered streams of step (s).

7. The method of claim 6 wherein step (q) is performed using the FFTpc algorithm using the with-rotation option.

8. The method of claim 7 wherein step (f) separates the sdvec into p−1 streams, where the sdvec is of size n=2^{p} and p is an integer.

9. The method of claim 2 wherein step (f) separates the sdvec into a number of streams equal to the number of parallel processors available to perform parallel processing of data, with each stream being of equal size, the method further comprising steps:
(t) processing each stream from step (f) in parallel by either the FFTpc algorithm or the pDCTs algorithm as follows:
(1) processing the portion of the stream containing the first size−4 portion of the sdvec by the FFTpc algorithm;
(2) processing any remaining portion of the stream of step (t)(1) by the pDCTs algorithm; and
(3) processing each other stream by the pDCTs algorithm;
(u) transforming a filter function into frequency domain;
(v) separating the transformed filter function from step (u) into the same number of component filters as the number of the plurality of streams from step (f);
(w) filtering in parallel each of the plurality of streams from step (t) by the respective component filter of step (v) by calculating their term-by-term product;
(x) processing each filtered stream from step (w) in parallel by either the reverse FFTpc algorithm or the pDCTs algorithm as follows:
(1) processing by the reverse FFTpc algorithm the portion of the stream that was processed in step (t)(1);
(2) processing by the reverse pDCTs algorithm any remaining portion of the stream that was processed in step (t)(2); and
(3) processing by the reverse pDCTs algorithm each stream that was processed in step (t)(3);
(y) concatenating all processed streams from step (x) to match the order in which the streams were separated in step (f); and
(z) ascertaining the portions of the concatenated result from step (y) to correspond to the portions of the sdvec that was separated in step (f);
wherein:
the streams added and subtracted in steps (g)-(h) are the ascertained portions from step (z); and
each parallel processor processes one stream in steps (t), (w), and (x) in parallel with the other parallel processors.

10. A method for processing data in parallel comprising the steps of:
(a) separating input data into a plurality of streams by a computer executing the sumdiff function;
(b) transforming the plurality of streams from step (a) into frequency domain in parallel using parallel processors, wherein:
(1) at least a portion of at least one of the plurality of streams is transformed using the FFTpc algorithm; and
(2) the other portions and streams are transformed using the pDCTs algorithm;
(c) transforming the frequency-domain plurality of streams from step (b) into time domain in parallel using parallel processors, wherein:
(1) the portion corresponding to step (b)(1) is transformed using the reverse FFTpc algorithm; and
(2) the portions and streams corresponding to step (b)(2) are transformed using the reverse pDCTs algorithm; and
(d) combining the plurality of streams from step (c) into output data by executing the sumdiff function.

11. The method of claim 10 wherein the input data is two-dimensional.

12. The method of claim 10 wherein the input data is three-dimensional.

13. A method for processing data in parallel comprising the steps of:
(a) partitioning two-dimensional input data along the first dimension into a first half and a second half;
(b) adding the first half from step (a) to the second half from step (a) term-by-term to produce a first half of a first temporary matrix;
(c) subtracting the second half from step (a) from the first half from step (a) term-by-term to produce a second half of the first temporary matrix;
(d) partitioning the first temporary matrix from steps (b)-(c) along the second dimension into a first half and a second half;
(e) adding the first half from step (d) to the second half from step (d) term-by-term to produce a first half of a second temporary matrix;
(f) subtracting the second half from step (d) from the first half from step (d) term-by-term to produce a second half of the second temporary matrix; and
(g) partitioning the second temporary matrix from step (f) into at least four subregions,
wherein steps (a)-(g) are performed by one or more computers.

14. The method of claim 13 further comprising steps:
(h) processing the first of the at least four subregions from step (g) by:
(1) processing each vector of the first subregion along the first dimension by the FFTpc algorithm to produce a first temporary subregion; and
(2) processing each vector of the first temporary subregion of step (h)(1) along the second dimension by the FFTpc algorithm to produce a first frequency-domain subregion;
(i) processing the second of the at least four subregions from step (g) by:
(1) processing each vector of the second subregion along the first dimension by the FFTpc algorithm to produce a second temporary subregion; and
(2) processing each vector of the second temporary subregion of step (i)(1) along the second dimension by the pDCTs algorithm to produce a second frequency-domain subregion;
(j) processing the third of the at least four subregions from step (g) by:
(1) processing each vector of the third subregion along the first dimension by the pDCTs algorithm to produce a third temporary subregion; and
(2) processing each vector of the third temporary subregion of step (j)(1) along the second dimension by the FFTpc algorithm to produce a third frequency-domain subregion; and
(k) processing the fourth of the at least four subregions from step (g) by:
(1) processing each vector of the fourth subregion along the first dimension by the pDCTs algorithm to produce a fourth temporary subregion; and
(2) processing each vector of the fourth temporary subregion of step (i)(1) along the second dimension by the pDCTs algorithm to produce a fourth frequency-domain subregion,
wherein steps (h)-(k) occur in parallel.

15. The method of claim 14 further comprising steps:
(l) processing the first frequency-domain subregion from step (h)(2) by:
(1) processing each vector of the first frequency-domain subregion along the second dimension by the reverse FFTpc algorithm to produce a fifth temporary subregion; and
(2) processing each vector of the fifth temporary subregion of step (l)(1) along the first dimension by the reverse FFTpc algorithm to produce a first time-domain subregion;
(m) processing the second frequency-domain subregion from step (i)(2) by:
(1) processing each vector of the second frequency-domain subregion along the second dimension by the reverse pDCTs algorithm to produce a sixth temporary subregion; and
(2) processing each vector of the sixth temporary subregion of step (m)(1) along the first dimension by the reverse FFTpc algorithm to produce a second time-domain subregion;
(n) processing the third frequency-domain subregion from step (j)(2) by:
(1) processing each vector of the third frequency-domain subregion along the second dimension by the reverse FFTpc algorithm to produce a seventh temporary subregion; and
(2) processing each vector of the seventh temporary subregion of step (n)(1) along the first dimension by the reverse pDCTs algorithm to produce a third time-domain subregion; and
(o) processing the fourth frequency-domain subregion from step (k)(2) by:
(1) processing each vector of the fourth frequency-domain subregion along the second dimension by the reverse pDCTs algorithm to produce a eighth temporary subregion; and
(2) processing each vector of the eighth temporary subregion of step (o)(1) along the first dimension by the reverse pDCTs algorithm to produce a fourth time-domain subregion;
wherein steps (l)-(o) occur in parallel.

16. The method of claim 15 further comprising steps:
(p) combining the time-domain subregions of steps (l)-(o) into a third temporary matrix, where the time-domain subregions are located within the third temporary matrix to correspond to the locations of their source subregions within the second temporary matrix in step (g);
(q) partitioning the third temporary matrix of step (p) along the first dimension into a first half and a second half;
(r) adding the first half from step (q) to the second half from step (q) term-by-term to produce a first half of a fourth temporary matrix;
(s) subtracting the second half from step (q) from the first half from step (q) term-by-term to produce a second half of the fourth temporary matrix;
(t) partitioning the fourth temporary matrix from steps (r)-(s) along the second dimension into a first half and a second half;
(u) adding the first half from step (t) to the second half from step (t) term-by-term to produce a first half of a fifth temporary matrix;
(v) subtracting the second half from step (t) from the first half from step (t) term-by-term to produce a second half of the fifth temporary matrix; and
(w) dividing the fifth temporary matrix by 4 and setting the result as the output data.

17. The method of claim 16 further comprising steps:
(x) wirelessly transmitting the frequency-domain subregions of steps (h)-(k) by a transmitter; and
(y) wirelessly receiving the transmitted subregions of step (x) by a receiver,
wherein:
steps (a)-(k) are performed by a first computer having parallel processors;
steps (l)-(w) are performed by a second computer having parallel processors; and
steps (l)-(o) are performed on the subregions received in step (y).

18. The method of claim 16 further comprising steps:
(z) transforming a two-dimensional filter function into frequency domain;
(aa) separating the transformed filter function from step (z) into the same number of component filters as the number of subregions from step (g); and
(bb) filtering in parallel each frequency-domain subregion from steps (h)-(k) by the respective component filter of step (aa) by calculating their term-by-term product;
wherein steps (l)-(o) are performed on the filtered subregions of step (bb).

19. The method of claim 16 further comprising steps:
(cc) for each subregion of step (g), setting that subregion as the input data and repeating steps (a)-(g) to further partition each subregion into at least four sub-subregions;
(dd) performing in parallel steps (h)-(o) for each set of sub-subregions from step (cc);
(ee) performing steps (p)-(w) for each set of sub-regions processed in step (dd);
(ff) combining the output data from each iteration of step (w) for each set of sub-regions processed in step (ee) and setting as the third temporary matrix; and
(gg) repeating steps (q)-(w) on the third temporary matrix set in step (ff).

20. The method of claim 18, wherein the input data is an image.
